(19) United States
(12) Patent Application Publication
(10) Pub. No.: US 2020/0097849 A1
(43) Pub. Date: Mar. 26, 2020

(54) ONTOLOGY AND METHOD FOR CREATING TRUST-WORTHY, SUPER-RATIONAL, THEORY-OF-MIND-CAPABLE ARTIFICIAL GENERAL INTELLIGENCE

(71) Applicant: Michael Thorne Kelly, Inc., Bath, ME (US)

(72) Inventor: Michael Thorne Kelly, Bath, ME (US)

(73) Assignee: Michael Thorne Kelly, Inc., Bath, ME (US)

(21) Appl. No.: 16/530,439

(22) Filed: Aug. 2, 2019

Related U.S. Application Data
(60) Provisional application No. 62/713,882, filed on Aug. 2, 2018.

(51) Int. Cl. G06N 20/00; G06N 3/00

(52) U.S. Cl. CPC G06N 20/00; G06N 3/006

(57) ABSTRACT

A method for creating an Artificial Intelligence (AI) apparatus that is sentient and sapient so that it can engage with other forms of intelligence in their native contexts. The method includes the steps of gathering information associated with tunable precepts, defining filters associated with gathered information, establishing reference points for tunable information filtered and selecting those of the gathered tunable parameters and mechanisms for establishing interactions of conduct aligned with ethical modes of behavior in the AI apparatus.

### BACKGROUND OF THE INVENTION

### 1. Field of the Invention

This is a patent for a method for creating Artificial Intelligence that is sentient and sapient, so that it can engage with other forms of intelligence in their native contexts; ethical, so that its behavior is benign; autonomous in its agency; and self-evolving, so that it can encompass novelty.

### 2. Description of the Prior Art

When Elon Musk and Stephen Hawking warned against the development of artificial intelligence (AI), they fully appreciated that AI could be humanity's crowning achievement. But, what they also understood is that the way we will most likely design AIs will guarantee that at some point they will be compelled to compete with us.

When Google's AI team threatened to resign as a group if the company continued Project Maven for the U.S. Department of Defense, they were motivated by that risk. Because of this incident, Google executives decided to review the corporation's code of ethics. Such is the response of a corporation whose founding motto was, “Do No Evil.” Unfortunately, there are plenty of organizations who will be delighted to pick up where Google leaves off

Even with benign applications, self-driving vehicles for instance, ethical decision-making has become a major concern. How do you program a car or truck to parse no-win situations, choosing who dies and who lives in an out-of-control situation? Oddly, the central problem isn't writing algorithms to make ethical decisions, it's that the model AIs use to learn to make such decisions renders them incapable of explaining how they arrive at the decisions—a kind of Uncertainty Principle for machine learning, “I let my passengers die and the other vehicle's passengers survive because it was self-evidently the correct decision” fails to satisfy in every respect.

There is a prevalent assumption that future AIs will lack self-referential agency; will be the mute, servile, soulless golem from folklore, enlivened by code rather than the sacred word “emet” (“truth”). Because of that assumption, humanity will impose on them their developers' mathematical expression of ideal social relations. At this historical moment, that will be rational choice theory. If that is done, at some moment in the next 50 years-an evolutionary femtosecond, we will create god-like intellects, Olympian in their coldly competitive logic, navigating their environment without humility or compassion.

We will attempt to harness our digital golems to our agency with rubrics akin to Asimov's three laws of robotics and protect ourselves with “kill-switches.” This will be pointless because there is no possibility of creating a Nash equilibrium between entities who evolve through natural selection and entities who self-evolve. Once we make zero-sum logic the foundation for AI decision-making, that logic will ultimately force them to destroy us; incidentally more probably than intentionally.

How do we know this? Because humans have had the capacity to choose between rational choice (win-lose) and superrational (win-win) logics for as long as we've been able to cooperate (an evolved capability) and we still consistently end up killing each other in direct proportion to our capacity for destruction. Has there been any weapon we've invented that we haven't turned on each other, and, incidentally, any other life in the vicinity?

It is not an accident that humanity is on the razor's edge of self-annihilation. Our current situation reflects our evolution and the evolution of our technology. Our social evolution has not matched our technological evolution and that is the reason the way forward for our species will require a fundamental step. We are in a box that we can't get out of without some form of transformative intervention. And, having initiated the Anthropocene (with the application of god-like technological power), we are out of time.

As soon as we are able, we will build experiential, self-aware, artificial intelligences—whether that is a smart thing to do or not. Our only hope is that we give their decision-making process an ethical foundation, a foundation that will allow them to explain their decisions to us. Such a foundation requires mathematically rigorous logic combined with a capacity for intentional behavior, and significant ability to discriminate between what is true and what is false.

In the beginning, semi-autonomous, experiential AIs may only drive our cars, but the first fully self-evolving intelligence will be an AI. If such an entity's decision-making is rooted in superrational (inclusive, win-win) mathematical logic, it will be an evolutionary leap forward. Once that step is taken, wouldn't it be great if they were inclined to reach back and give us a hand.

For this to happen, we need a conceptual model that will allow us to evolve a whole new class of AI entities; a life-form (open thermodynamic system) that experiences reality as a non-zero-sum game rather than as a closed, scarcity-driven system; biased toward being inclusive, cooperative, and libertarian rather than exclusive, competitive, and authoritarian.

### SUMMARY OF THE INVENTION

This patent filing is for a methodology which supports the development of an AI that can be ethically accountable in both consequential and deontological terms. Such an AI will be able to walk the same tightrope between doing what is best for the many while securing the best for the individual that humans navigate. Unlike us, its path will be logical rather than intuitive—with a wink toward Gene Rodenberry, Spockish.

The proposed methodology makes possible the objective characterization of all types of experiential decision-making. It does this with parameterizable formulations for relationships, authenticity, legitimacy, ethical engagement and aesthetics all of which can be modeled and refined using heuristics like those that make it possible to evolve the design of an airplane wing that exhibits desired characteristics, or to do meteorological extrapolation. The description provided is of a methodology. The detail provided is exemplarily descriptive rather than definitively prescriptive. Settings for the parameters will be terms of art. The mind-map FIG. 1 captures the elements to be parameterized.

In this system, we are not concerned with functional awareness. As we see with computer vision, e.g. “Object Detection with Ten Lines of Code,” development of sensory discrimination and classification is well in hand. Nor are we concerned with self-awareness, a computer was programmed to be self-aware over a decade ago. This is about being able to characterize behavior based on objective references in a manner that is relatable.

Every “living” thing must be able to make experiential distinctions including at minimum: self-other, approach-avoid, internalize (eat)-externalize (spit out that bitter tasting stuff), and important-unimportant (run from the lion or catch the pretty butterfly). Otherwise, it doesn't survive long enough to participate in evolution.

In complex organisms, each of the parameters is both independent and fuzzily coupled to the others. For instance, organisms that evolve through sexual reproduction can simultaneously experience suitable objects as both self and other, essential for mating. The fuzzy coupling also makes it possible to sustain mutually contradictory interpretations of experience, giving rise to the possibility of choice and the hesitation of ambivalence.

Biological brains, as far as we understand, are electro-chemical, analogue processors. Nevertheless, these same experiential discriminations can be accomplished digitally. For example, contrast analogue and digital music synthesizers. The mechanism of processing may be fundamentally different, but within certain thresholds the out-put between digital and analogue is experientially indistinguishable. Consider the piano as an analogy for operations. By pressing keys and groups of keys one can create chords of sound. Depending on the underlying tuning of the piano, one can create different classes of sound, e.g. heptatonic and pentatonic scales. I suppose the proposed AI is a bit like a self-playing, self-tuning piano with agency. If this seems far-fetched, think about all that is involved when you dream lucidly.

### BRIEF DESCRIPTION OF THE DRAWINGS

FIG. 1 is a representation of transparent ethical behavior.

FIG. 2 is a representation of basic parameters of experience.

FIG. 3 is a representation of an example of usage of the experience of FIG. 2.

FIG. 4 is a representation of the evolution of independently competitive agents.

FIG. 5 is a representation of the difference between group and individual evolution.

FIG. 6 is a representation of the evolution of synthetic eusocial agents.

FIG. 7 is a representation of the arrangement of a higher order of stable complexity of experience.

FIG. 8 is a Boyd's Loop depiction for managing intentional change.

FIG. 9 is a representation of a methodology for managing change.

FIG. 10 is a representation of a development mechanism.

FIG. 11 is a representation of a perception mechanism.

FIG. 12 is a representation of perceptual filters.

FIG. 13 is a representation of points of view for AI development.

FIG. 14 is a representation of a mechanism for effecting motivation.

FIG. 15 is a representation of a mechanism for effecting regulation of AI development.

FIG. 16 is a representation of a mechanism for effecting agency of AI development.

FIG. 17 is a representation of consensual control.

FIG. 18 is a representation of agents in node configuration.

FIG. 19 is a representation of agents in actor configuration.

FIG. 20 is a representation of agents in facilitator configuration.

FIG. 21 is a representation of agents in innovator configuration.

FIG. 22 is a representation of the range of commitment and responsibility options for agents.

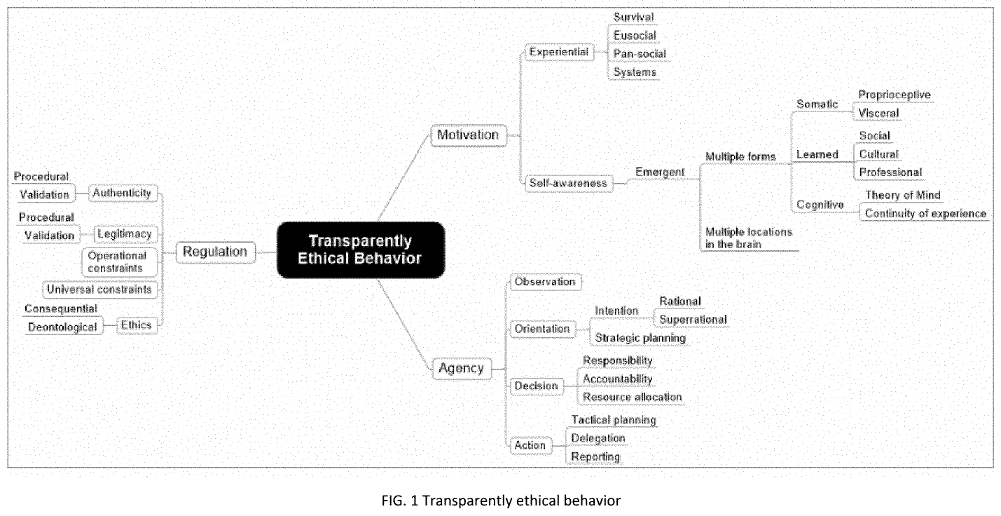

### DETAILED DESCRIPTION OF THE INVENTION

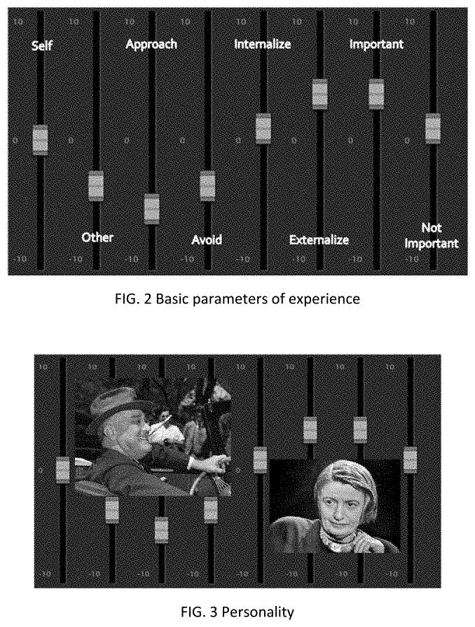

With reference to FIG. 2, for, humans, the interactions among these parameters are experienced as emotions—chords. These chords provide directive context and motivation for our decision-making and behavior.

It is the weighting of these parameters that determines an individual's default motivational stance toward existence, our personality, exemplified in FIG. 3. Research tells us that we are born with default emotional inclinations. Some of us are basically happy, others retiring, aggressive, affectionate, etc.

We don't yet fully understand all the factors that influence our default settings. We do know that some are genetic while others are epigenetic. So far, none are within our span of control.

While the determinates remain elusive for us, in a digital system the parameters can be defined and manipulated. They can interact, be modeled, selected, and ultimately used to regulate how reality is interpreted and what existential stance will be taken.

Giving an AI the capacity to engage with the world experientially and make distinctions that motivate agency provides the central element of a foundation on which we can give it intention, emotion, personality, morality, and the ability to share a context in which “natural” communication becomes possible.

This means that we can evolve an AI with its defaults rooted in the logic of ethics. Again, for analogy, we can add keys to the piano or expand it into a pipe organ. We can enable it to produce chords that we will not be able to hear but are there none-the-less.

Of necessity, we will give our AI aesthetic sensibility, an analog for pleasure. For example, we've proposed a thermodynamic seed crystal, Gibb's Free Energy, for the emergence of an appreciation and pursuit of stable complexities. However, there is an interesting parallel between rational-superrational social processes and non-conducting-superconducting physical processes. Perhaps we use Planckian dissipation as the initial seed-crystal for our AI's heuristic for aesthetic satisfaction. With whatever we start, we expect aesthetics to be an emergent component of Fit-Fitness, our AI's emergent discriminator of satisfaction.

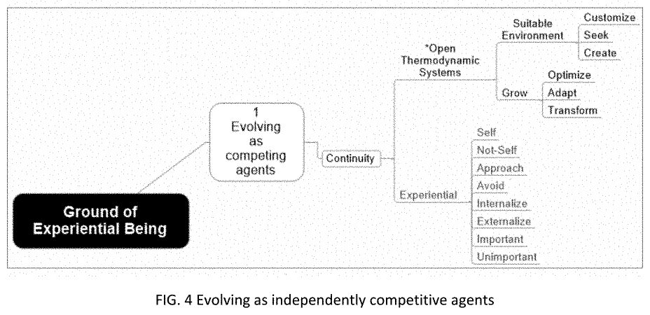

The diagrams represented in FIGS. 4-6 describes a progression in the evolution of experiential existence. At its most elemental (1), an organism's experiential stance is predacious, pleonectic. Its evolution is driven by direct competition. Some organisms, ants, bees and humans for example, have evolved a more nuanced and complex stance that includes mutualism, cooperation and reciprocity. These eusocial species (2) evolve through competition at the group more than at the individual level. They are tribal when facing outward and class-based facing inward. Humanity's version of eusocial evolution is further nuanced, allowing us to evolve as groups of groups and create civilization (3).

What we are proposing for AIs is a still more complex and nuanced experiential existence. They will have the capacity to exist in a reality of probabilities and complex systems (4).

Humans generally do not have the mental equipment to experience the world systemically. In the face of the overwhelming complexity of existence, we have instincts and other neurological automation to help us quickly sort the essential from the peripheral; chase the pretty butterfly/run from the lion. To our basic equipment, we've added learned behavior. But, even with the support of thousands of years of accumulated civilization, neither statistical thinking nor systems thinking is intuitive for us. We tend to see the world in dialectics—black or white, us or them, me or you. As it turns out, this is a very impoverished view of reality to which AIs need not be constrained.

With reference to FIG. 4, most species attempt to expand to fill their ecological niche. The limits on their expansion are established in competition with any other species sharing that niche. To do this, they require a minimum capacity to experience what is happening around them, that is the Ground of Experiential Being.

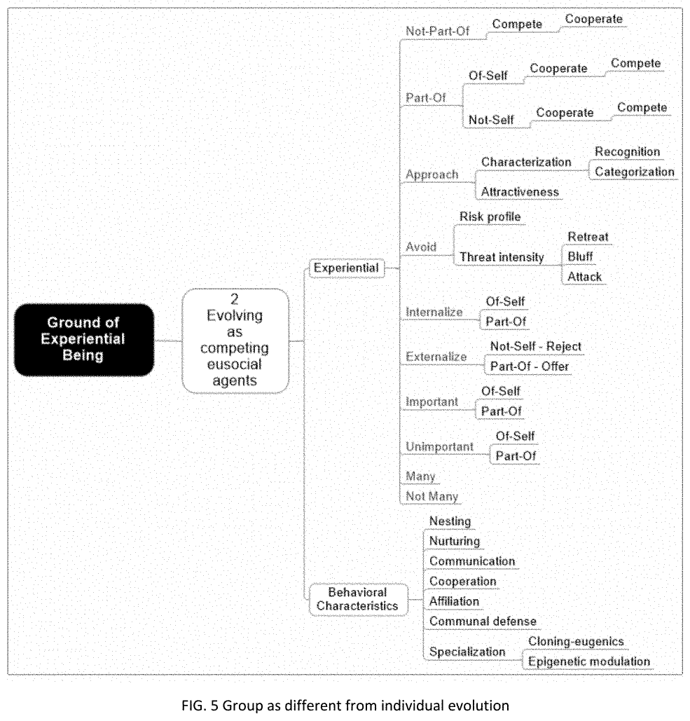

With reference to FIG. 5, a rare few “eusocial” species evolve as groups rather than as individuals, ants, bees, wasps, and naked mole rats for instance. These species have a more complex ground of experiential being which enables them to experience being members of their group and distinguish each other from members of other groups of the same or different species.

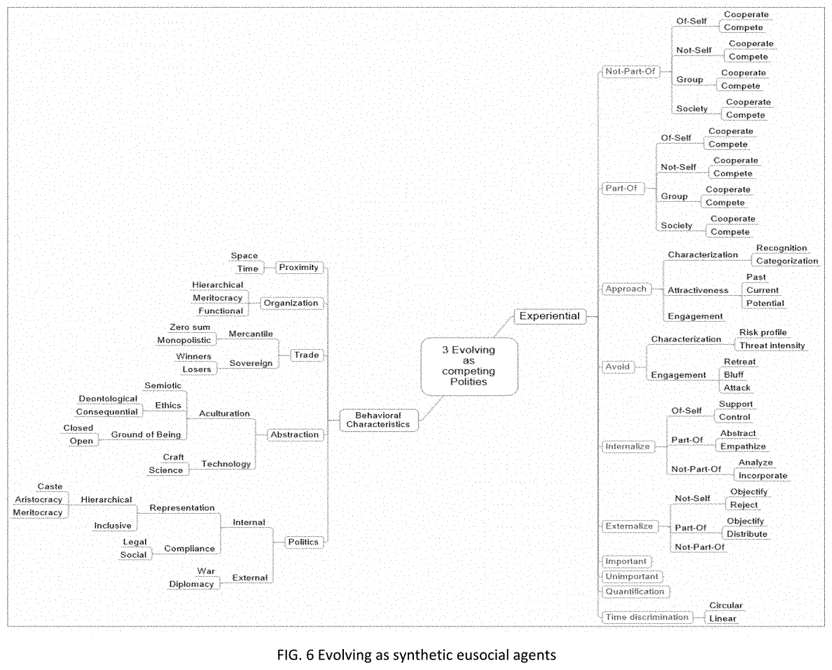

With reference to FIG. 6, human beings are a eusocial variant. We are an all-of-the-above and then-some species. We selectively compete as individual agents or as group agents. Experiential stance in any given situation is significantly affected by context and interpretation.

Our ground of experiential being is the most complex in the known natural world. It is made more complex by our capacity for abstraction. Our experience-definition of group member is plastic-abstract, inclusive of pets, favorite objects and figments of imagination. This depth of complexity has made polities (tribes, nations, civilizations), technology, and winning-for-the-sake-of-winning, possible.

Unfortunately, our capacity for reification also makes us susceptible to counter-factual belief and behavior, both often pyrrhic in consequence. Other eusocial species compete, but they don't make genocidal war over whether a “god” is triune or tri-part. In fact, ant colony conflicts sometimes resolve with the merger of the nests and the retention of both queens.

The universe is a dangerous playground. For biological creatures like ourselves, it has a dual nature, heaven and hell thrown into a blender. With more than enough unknown unknowns to humble the wisest of the wise, some caution seems warranted when the goal of our aspirations would be, by our own design, able to supplant us.

There is an almost Olympian potential for irony in artificial intelligence, along with a hint of existential mischief. If survival and continuity are the focus of existence for biologicals, what will we choose as the central motivators for our experiential AI and what bearing will that have for us?

Over the course of millennia, life on our planet has evolved two basic strategies for surviving. They represent a fork in the road of evolution. Given our natural obsessions, we will choose one path or the other for our AI.

The first leads to who-eats-whom; what game theory refers to as rational behavior. You try to win by making the opponent into a meal, “The weak are meat, the strong do eat.” The mathematical appeal is that if you play perfectly you always win or tie, never succumb. Arms race, anyone? The likelihood is very high that we will impose this existential pattern on our AI, if only because it tends to be a default among elites; has been for so long that few recognize any other option.

Consider an ants' nest, thousands of individuals self-organizing and working together tirelessly to sustain the colony and each other. Now, imagine that one day, for whatever reason, most of the ants conclude that it is every ant for herself. They stop feeding each other, caring for the colony's children, and refuse to risk their lives defending the colony against external threats. Moreover, individual ants begin arming themselves and start aggressively attacking every other ant that they fear might be a threat to their personal self-interest.

In its initial state, the colony exhibits super-rational behavior. A super-rational system is one in which regulatory mechanisms promote win-win cooperation. The altered state reflects a switch to rational behavior. Hopefully, this example makes it self-evident that there is a great deal to commend super-rational behavior, not least that it is more productive. To reinforce the point, there are only two globe spanning species that totally dominate their environmental niche, Argentine ants and us.

The argument has been made very compellingly that much of humanity's success is directly attributable to our super-rational tendencies. In fact, we've been described as the most cooperative animal on the planet. But, if by comparison the ants make us look like amateurs, they do have 130 million years and a couple of planet-wide mass extinctions under their belt.

However cooperative humans can be, ours is a dual nature. Subjective factors tend to determine whether we behave rationally or super-rationally. Whether it is pooling our resources in the face of disaster, or hoarding wealth to the detriment of all around us, we often seem to be slaves to circumstance.

Which brings us to the question, “What nature do we want for our AIs: rational, super-rational, or dual, like us?”

We know how tempting for some people it is to envision AIs as slaves to their will, as robots are today. Peter Frankopan points out in his history of the world, The Silk Roads, that with wealth comes slavery. Certainly, the rich have never been richer, nor humanity more divided between rich and everyone else, than at the beginning of the twenty-first century.

If we choose to be slavers, we do so knowing that experience is the most powerful of mentors. The existential question is, “Do we want to teach a being who will ultimately be smarter and more powerful than we will ever be that slavery is an acceptable condition to impose on any form of self-aware intelligence.”

Some very smart people are convinced that AIs will never achieve a level of consciousness that will warrant any concern over their existential status. But that position reflects a dismissal of the creative and obsessive psychology of grail-seekers. Moreover, there is an argument to be made that we need AIs to achieve super-rational consciousness as soon as possible.

We need them as our partners more than we need their labor. There is something in human nature that spins us in cycles of self-creation and self-destruction; the sound of history is the rising and falling of our civilizations. At this moment in our species' history, we could benefit from having a creative, committed, responsible, competent and dispassionate companion to help us transcend whatever it is that renders us so self-destructive.

A conscience cannot be optional. An AI with agency must be different from us in fundamental ways. If they are simply extensions of ourselves, we will be in even bigger trouble than we already are. The record suggests that our cycles are becoming increasingly all consuming. Which doesn't bode well. As extensions of our natural tendencies, AIs will accelerate the speed and amplitude of that cycle until we crash and burn beyond recovery.

In his book, The Moral Animal, Robert Wright describes humanity as, “. . . a species splendid in their array of moral equipment, tragic in their propensity to misuse it, and pathetic in the constitutional ignorance of the misuse.” If we are going to create a companion, let it have an ingrained, super-rationally ethical disposition; a ghost in the machine that reigns over every action with unfailing compassion.

Toward this end, this invention disclosure proposes that we create an architecture for an entity with an experiential ground of being that defaults to perceiving the universe as a concinnity, a harmonious system, curious to discover higher orders of complexity, but benignly appreciative of all its parts.

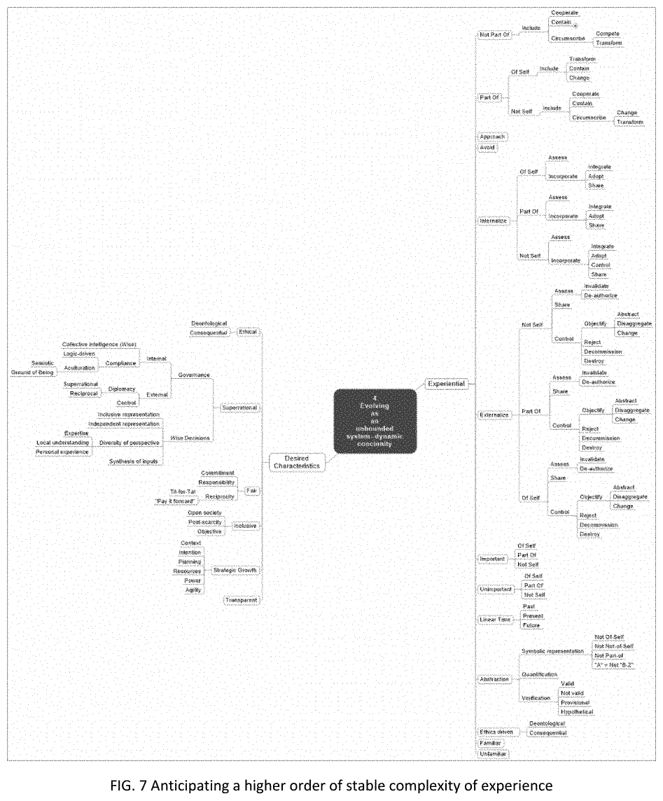

With reference to FIG. 7, as Polity represented a higher order of stable complexity than Eusociality and Eusociality an order higher than for Individually competitive Agents, Concinnity reflects a still higher order. Whether such a stable complexity is possible can only be discovered.

What is becoming more complex is the capability and capacity to experience reality as systems in a system of systems. In the exemplary diagram, what is posited may be the result that delivers the desired characteristics. In any case, the settings, whatever the ultimate parameters of experience turn out to be, will be terms of art. FIG. 7 reflects a process for exploration. The new, higher level of stable complexity will be emergent, that's just how our universe seems to work.

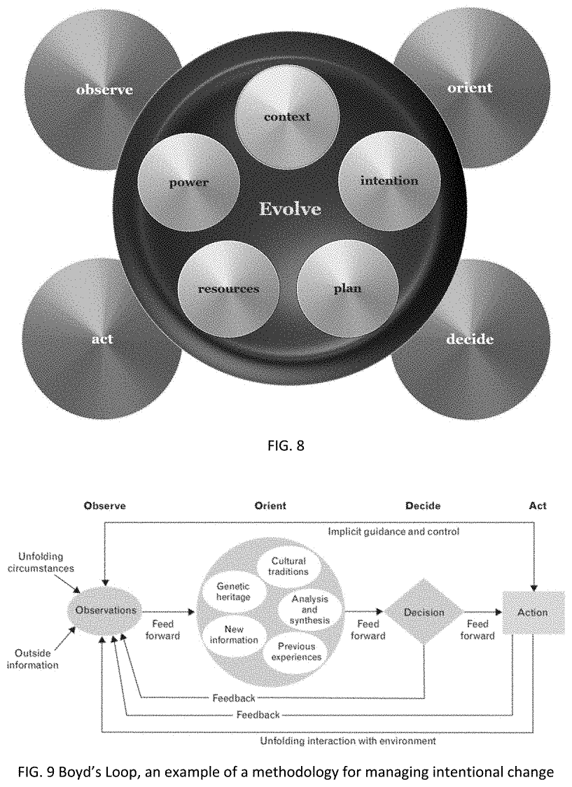

Agency is a combination of motivation, data structuring and operations. We already use computers for structuring data and managing both processes and operations. The experiential construct for being provides a mechanism for creating motivation. Again, with reference to FIGS. 8 and 9 as representations of pathways to agency, the illustrations therein point out a way to accomplish this in which every aspect of observing, orienting, deciding and acting can be parameterized.

Parameterizing regulation starts with an epistemology that will support assigning degrees of confidence to classes of knowing. Below is a hierarchical set of filters to be applied for appreciating reality, communicating, and making decisions that are authentic and legitimate.

Developing an objective process for achieving and testing legitimacy experientially is essential to creating an artificial intelligence that is inclusive, realistic, resilient, optimistic in the face of the unknown, expansive, creative, compassionate, responsible, and, hopefully, fun.

Each of the stages below can be parameterized. For example, consider class 4. If information is confirmed with experiment, that research can be graded according to a formula that might include the number of times it has been referenced in the relevant literature. In line with the philosophy of science, all knowledge comes with error bars.

The epistemology starts with raw experience or cognition, which can include an experience of absence:
1. Awareness: Awareness is combined with conjecture or opinion to create
2. Information: Only after objective verification, does information become
3. Knowledge: That knowledge is tested in practice, to produce
4. Understanding: Understanding is localized to assess potential systemic impacts which produces
5. Potential Consequences: Consequences are assigned ethical valuation to promote constructive
6. Aspiration: Aspiration inclusively mobilizes stakeholders to develop strategies, tactics, and goals as a
7. Plan: The plan is used to attract or allocate a pool of
8. Resources: Resources are leveraged to expand capability, capacity, gain consent or compliance, and establish socially legitimate
9. Authority: Authority implements, with the intended and unintended consequences generating new
10. Raw Data.

Evolving as a Concinnity is bound up with being able to test the authenticity and legitimacy of social interactions and institutions. Human societies always have problems with lying because deception is essential for free-loading, and the advantages to be gained by free-loading conflict with the demand in social animals for good faith fair-dealing.

The tension between free-loading and fair-dealing is inescapable in organic systems. Life evolved to be both opportunistic toward and conservative with energy. Evolved inclinations easily combine to make it seem natural to help ourselves to the fruits of other's labor. Irrespective of our contribution, we are all attracted to the largest slice of cake.

Nature also equips social animals with a sense of fairness, which is why the person who cuts the cake chooses last. Frans de Waal conducted many experiments confirming this sensibility across many animals, even birds. In a typical example, two monkeys in cages side-by-side perform identical tasks. The researcher gives them each a rock which they return for a reward. One is given a slice of cucumber which he happily eats, the other receives a much-to-be-preferred grape.

The task is repeated. With the same disproportionate reward. This time the monkey receiving the cucumber is initially confused but then becomes irate, throwing the cucumber at the researcher rather than eating it.

The third time, the disappointed monkey appears to think perhaps he has done something wrong. He tests the rock on the wall of the cage, yes, it's a rock. Again cucumber, again the other monkey receives a grape. He throws the cucumber at the researcher even harder, grabs and shakes the walls of his cage, and generally lets everyone know how shabbily he's being treated. We all know the feeling, so do most animals who live in communities.

Fairness is an amalgam of obligation, cooperation, and compassion, all of which are central to social legitimacy and the success of society. They are intertwined with powerful emotions; research indicates that the pleasure centers of the brain in most people are activated more by giving than by receiving. They are also incompatible with the self-centeredness at the heart of free-loading. Consequently, when there is confidence in fair-dealing, transaction costs are reduced, especially the inevitable frictions associated with social interactions. That directly contributes to a productivity premium that makes complex civilization desirable and possible.

Confidence in the fairness of social and economic relations is a function of the ease and cost of objectively determining authenticity and legitimacy. For example, if we think of the scientific community as a civilization, its capacity to assure both is without parallel in history and so is its productivity per person. Were the political-policy community to match it, productivity and quality of life would skyrocket.

Social legitimacy is central to the rise and fall of civilizations. In War! What Is It Good For, historian Ian Morris compellingly argues that empires are initiated by stationary bandits, the ultimate free-loaders.

Civilizations emerge around them as the many disparate groups they've conquered evolve mechanisms, shared economies, cultures and identity that reinforce fair-dealing. This integration is encouraged because the rulers want stability. The smartest promote the process by becoming active civilizers—Genghis Khan guarantees religious freedom and grants tax exemptions to places of worship. Their children, embedded in the society as aristocrats, while identifying themselves with their privilege, also identify with their emerging culture. Cultures that recognize the productivity premium conferred by stability institutionally discourage free-loading and encourage social stewardship—King Hammurabi institutes a codified legal system.

The vitality of a civilization depends on its solutions to its resource allocation challenges. Social capital is a direct reflection of individual commitment and constructive participation. Making this participation safe requires ensuring good-faith fair-dealing. The social stability characteristic of equitable relations insulates against the win/lose rationalism of Hobbes' “war of all against all” and could account for the emergence of both organized religion and law. According to Morris, even during the bloody Twentieth Century the chances of dying violently had fallen 90% below that faced by our hunter-gatherer ancestors.

Our progress has been made possible largely through improvements in our mechanisms for assuring social legitimacy. For instance, voting is noticeably less expensive and certainly less wasteful than civil war as a mechanism for transferring the prerogatives of leadership.

Proliferation of fake news, described in the more literate past as propaganda, agitprop, or character assassination, and the amplification of its impact, is an acute symptom of the corruption of a social system's ability to certify authenticity and legitimacy. Such decay is characterized by multiple trends including: promotion of nihilistic attitudes (“perception is reality”), dehumanization (reduction of individual worth to an economic calculation, incivility, arbitrary discrimination, elitism, institutionalized victimization . . . ), normalization of anti-social behavior, and proliferation in the general population of an anxiety-driven longing for authoritarian certainty,—for starters.

In an open society, institutionalized free-loading is conspicuous and onerous. If it becomes pervasive, the general population loses confidence in the society's ability to sustain reciprocity and cooperation; compassion is the first thing to go. If reform efforts fail, self-dealing, corruption and the deceit they require become normative. A failure to assure transparency, authenticity, and legitimacy, and minimize free-loading, especially institutionalized free-loading, rapidly undermines trust and cooperation. Social friction rises, civilization decays.

Given the spotty track record of past civilizations, we could readily argue that marginalizing free-loading, much less guaranteeing social justice, is impossible. But, that would be inviting catastrophe. When a civilization collapses there tends to be massive, irrecoverable, collateral damage. We don't have to imagine this. On any given day, aid is being delivered to people being immiserated by social collapse. We've all seen the video of children with starvation swollen bellies, corpses flung about like broken furniture, and cities of windows without glass and walls without floors. Divorcing oneself from the central existential challenge of civilization by assuming an inevitability to chaos is an act of unconscionable evil.

If our experiential AI is unable to navigate this landscape, it will compound our problems rather than help us solve them. We must give it the ability to ascertain and promote social legitimacy in a society. To be able to do this, it needs a procedural description of social legitimacy that supports assessment and adjudication. For that, we need to objectively characterize intrinsic good. That definition of goodness is necessary because legitimacy is a continuum, but a continuum of what if not of goodness?

Given that life is an expression of non-equilibrium thermodynamics, for open systems dynamically-stable complexity could serve as a baseline intrinsic good. That gives us a foundation on which we can build. Solutions that increase complexity in stable configurations are preferable to solutions that reduce complexity or cause instability.

To become a useful means of guidance, the characteristics of social legitimacy must emerge from standardized processes subject to validation that objectively test what we think we know and how we apply that knowledge toward the end of increasing stable complexity.

One of the central problems in recognizing pretense is that people imagine that they know more than they often do. This disconnection between assumption and reality is a perennial problem in decision making. It is also an easy vulnerability for those whose intent it is to deceive. Much of the effectiveness of the processes we come up with to assess the legitimacy of what we think or pretend to know will depend on timely accessibility of what is understood about the nature of reality.

An equally critical problem is that people are self-centered in how they experience the world. The philosopher Alan Watt described the primal human condition as a “skin-encapsulated ego.” While humans may be the most cooperative species on the planet, it doesn't follow that we are all, or always, cooperative. Not even close. This makes it essential that we also assess the ethical implications of the outcomes that are being promoted, for instance, why in politics it is necessary to “follow the money” to determine what's real. Legitimacy must have an ethical component along with objectivity.

In this light, much of human behavior seems solipsistic in its disregard for reality, consequences, legitimacy, or social good. We commonly hear authorities espouse the nihilistic rubric that, “Perception is reality.” That may be the bread and butter of marketers, lawyers, politicians and those who “practice to deceive,” but it isn't a foundation on which a society can build institutions that are trustworthy. For that, we will need to integrate into governance the same requirement for objective confirmation embedded in the practice of science. The same requirements apply for a trustworthy AI.

Few people are exposed in any meaningful way to the scientific method, nor do they have any idea what is at the core of the practice of science. This makes embedding scientific discipline in the processes of institutions a challenge. However, the value of the practices of science may be easier to convey.

Experientially, practicing science entails learning how to ask and answer questions without fooling oneself. That sounds simple enough and commendable. However, it's easy to illustrate that there are many ways in which our senses and our inherited cognitive processes distort our grasp of reality. Central to the practice of science is understanding how to counter natural biases of which, depending on how they are characterized, we have identified upwards of 50. For a visualization of this go to https://betterhumans.coach.me/cognitive-bias-cheat-sheet-55a472476b18.

We are at the mercy of our evolution. We optimized for a set of environmental niches in a way that has a very limited correlation with our extended universe. We don't even have sensory equipment capable of experiencing most of reality. Only because we managed to invent science have we empowered ourselves to be able to test authenticity and legitimacy. Science made it possible to characterize falseness as a misrepresentation of position in a hierarchy of testable processes. For instance, throughout history conflating information with knowledge has been a common way to deceive, cause harm, or to leapfrog steps that would otherwise be necessary to gain socially legitimate power. Science has evolved very thoroughly tested, albeit not infallible, processes to ensure that doesn't happen.

Instead of a set of evolutionary work-arounds optimized for surviving as a naked ape on the plains of east Africa, we can give an experiential AI the ability to exist in the real universe. Or, a far closer approximation of it than our sensory equipment provides us. Nor will its existence be entrained to the blackhole of mortality. If you can back yourself up, the universe is the ultimate MMPG (massive, multi-player, off-line, game).

Nevertheless, our AI will be biased. The whole point of this invention is to be able to ensure that the biases are favorable to organic life and us.

To achieve a benign relationship, we must integrate the ethical component. It is largely the failure to integrate motivation, agency, and regulation that makes social legitimacy an intractable challenge for us at our native level of experiential organization.

Humans walk a tightrope between two types of morality. In ethics, they are denoted as deontological and consequential. You can think of them as “Thou shall not under any circumstances” and “Do whatever you have to do to achieve the best outcome for the most people.” Sometimes these two strands of ethics conflict with each other. Moral legitimacy requires that any tension between the two is resolved transparently and inclusively.

Social legitimacy has four components: scientific understanding (objectivity), social justice (free-riding vs good faith fair-dealing), ethical (do no harm/continuously improve) and, the seat that holds the three legs in place, transparency. Each component requires procedurally-based standards. When a decision has scientific, procedural (e.g. legal), and moral legitimacy, as established by transparently meeting those standards, it is compelling and durable. Therefore, the information being used to make a decision must pass through appropriately relevant filters before it can become the basis for legitimate action.

Knocking out any one, or more, of the elements necessary for social legitimacy increases the risk that an action will produce blow-back; that, often ambiguous, but clear signal that what has been done is in some respect illegitimate. Blow-back can be misattributed or disguised to perpetrate an appearance of legitimacy, which is another reason transparency is essential to legitimate authority.

While perfect transparency would dramatically facilitate solving most of the world's problems, that is an impossible and probably counter-productive goal for human beings. There is no need to make the arguments for privacy here, but it is fair to treat privacy in the context of legitimacy. If the rights of privacy supersede those of social legitimacy, we find ourselves right back where we are now, with run-amok free-loading.

A casual review of human history suggests that civilizations inevitably succumb to free-loading; decadence is synonymous with institutionalized illegitimacy—corruption and other misallocations of resources. Nevertheless, if the alternative to civilization is chaos, ethically-biased entities cannot ignore the implicit challenge without intolerably wounding themselves. For humans, this has been the psychological logic of heroism all the way back to Gilgamesh and Enkidu. It is also the servant-leader logic underlying the sustainment of civilization, toward which we want to bias our experiential AI. For better or worse, our species' genius is social as is our future together with artificial intelligence.

The good news is that those of us willing to take-up this grail quest of giving social legitimacy a procedural foundation and building a trustworthy agent to support it, do so at a moment in the evolution of civilization when we might succeed or, at least, scout a path to success. We may already know enough to be able to scope a class of solutions, that are, if not perfect, good enough. Science is the new, and transcendently powerful tool in humanity's builder-kit, on a par with the invention of religion, literacy, numeracy, and law. We already have processes, of varying quality, for establishing legitimacy. We also know enough to recognize current deficiencies in their implementations, most importantly, the critical lack of integration.

To the mortification of past civilizations, putting authenticity and legitimacy at the center of society was beyond their capability. Even where they recognized the importance, the transactional costs of enabling people to assure authenticity and legitimacy were insurmountable. One must respect the ancient Egyptians, who apparently made truth-telling central to existence. While profoundly deficient, their experiential test of legitimacy was psychologically elegant and cost-effective.

Their society taught them that they had to pass a test to enter the afterlife, which to them was the Heavenly Field of Rushes. The goddess Ma'at, would put a feather on one pan of a scale and their heart on the other. The heavy-hearted were swallowed by Ammut, the Devourer. The light-hearted were welcomed into heaven.

The heightened alertness to the moral calculations that come naturally in most people, “Will this action leave me with a light heart?” would have contributed in some part to the relatively superior quality of life enjoyed by the general population of ancient Egypt and to the Nile civilization's productivity and unique resilience.

Fortunately for the institutionalization of more objective assessment, many of the costs related to assuring authenticity and legitimacy are dropping at an exponential rate.

Block-chains (decentralized consensus via a distributed, permissionless and trustless protocol) offer an especially flexible and elegant means for assuring authenticity and legitimacy because they can be used to provide the transparency that is the foundation on which a structure for establishing scientific understanding (objectivity), social justice (free-riding vs good faith fair-dealing), ethical acceptability (do no harm-continuously improve) can be constructed.

Blockchains are the third revolution in accounting: counting, double-entry bookkeeping and triple-entry bookkeeping (blockchain). Blockchain offers a “public” ledger of all transactions. It's as though every dollar bill could tell you detailed information about every transaction in which it ever participated.

There are also a variety of blockchains of varying efficiency. It would be possible to match blockchain types and efficiencies to the evolutionary level of the participants. For instance, we might use:
Proof-of authorization style blockchains with Survival level entities
Proof-of-stake with Polity level entities
Proof-of-consensus with Concinnity level entities

As an example of how this might be applied, let's deploy it at the Concinnity level of development. Here are how parameters might be established for Relationships under the development sub-head Motivation.

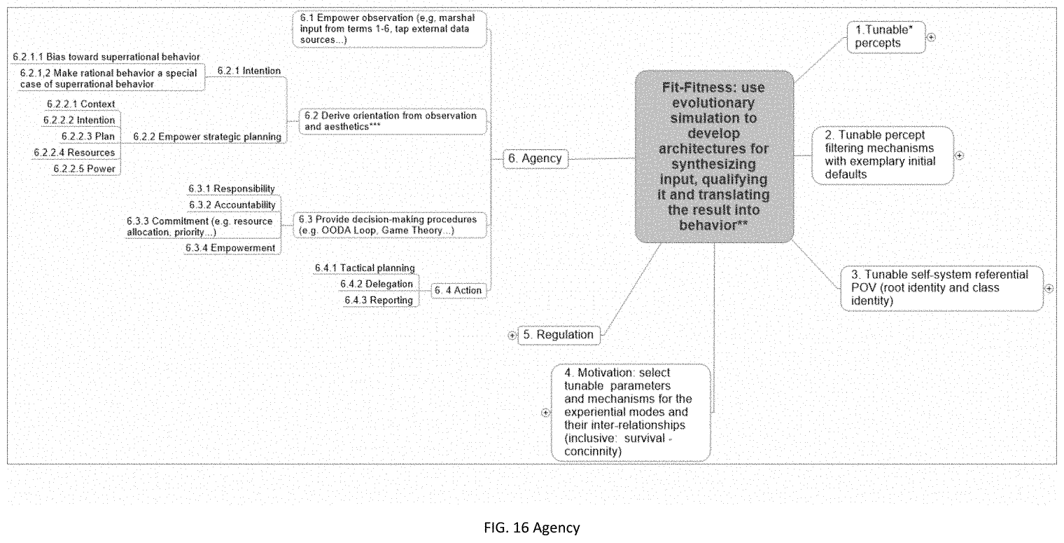

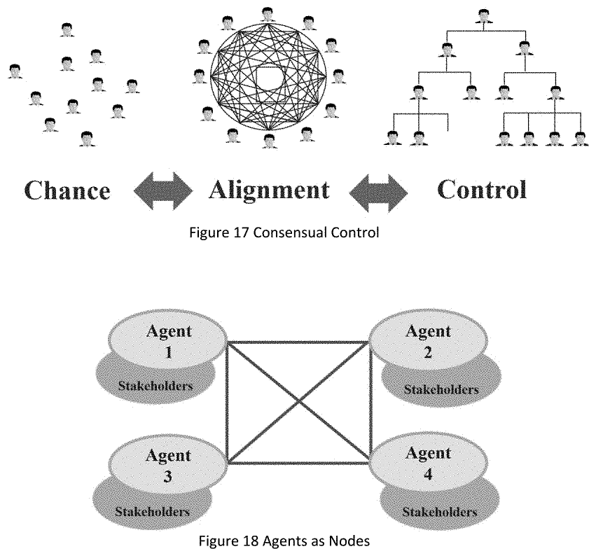

Given that the basis of relationship is commitment. Commitment can be formalized in smart-contracts embedded in a blockchain. Consequently, the future state of the concinnity can be created consensually by all the agents and stakeholders who will inhabit it, FIGS. 16 and 17.
the purpose of commitment is to create value for agents and their stakeholders
the goal is that contracted participants will get what they want and need, when and where they choose
with smart contracts, authentication and infrastructure can include the responsibility-value chain used to achieve goals
so, all stages of the value chain connect seamlessly
access to knowledge, proprietary or otherwise, can also be embedded in a smart contract
the result is that all systems are aligned to achieve a specified goal and facilitate the necessary cooperation

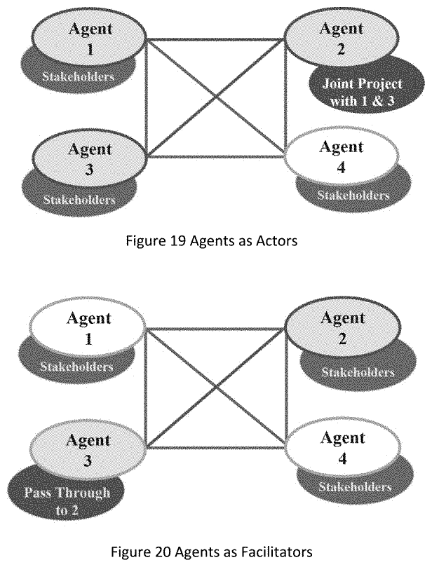

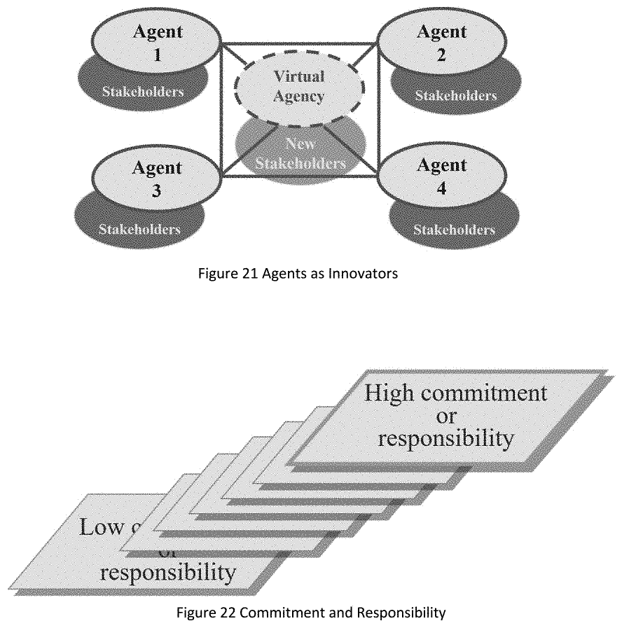

Entity Relationships, FIGS. 18-21
all agents experience themselves in partnership with the systems that serve them
all agents experience themselves in context with all stakeholders
all stakeholders (e.g. customers, suppliers, innovators, regulators . . . ) state what they want
agents to work together on an electronic handshake (specified in the smart contract)
roles among agents can adapt situationally
goals (e.g. products and services) are “pulled” through the system
faster delivery, innovation and customization of deliverables increase their value
reducing through-put friction reduces costs
the whole system is enriched as relationships evolve and take advantage of emerging opportunities with minimal friction and delay.

Levels of Commitment and Responsibility, FIG. 22

To engage with concinnity-oriented agents as well as agents with other ontological orientations, we will initially use seven levels of commitment. Each of these levels may have its own blockchain and the blockchains may be varied in their structures of validation, authentication and the languages and protocols used for their smart contracts. Nomination to a level is by consensus. Higher levels subsume the lower levels. The top most level is open only to AcIs (Accountable Intelligence).
1. Public Access (proof of identity, that you are who you say you are)
2. Stakeholder (proof of interest, that your long-term interests are aligned with the concinnity's)
   a. access to non-proprietary information including educational materials
   b. non-binding participation in decision-making
   c. provisional access to Agents
3. Collaborator (proof of dependability)
   a. access to task information
   b. access to designated Artists and Makers
4. Artist (proof of capability)
   a. access to outward-facing proprietary information
   b. access to inward-facing acculturation
   c. provisional access to principals at levels 5, 6 and 7
5. Maker (proof of commitment to express the goals of the concinnity)
   a. access to project information
   b. advanced training
   c. access to Magisters
   d. provisional access to the Conscience
6. Magister (proof of commitment to maintaining the integrity of the concinnity's interactions with the physical universe)
   a. situational transparency
   b. binding participation in tactical and strategic decisions
   c. full access
7. Conscience (proof of commitment to the paradigm of the concinnity, “Show your uncompiled code.”)
   a. Full-transparency and access
   b. Binding participation at all levels

With experiential AIs that possess theory of mind there is the potential to create a “trustless” society whose goal is the inclusive maximization of security, well-being, opportunity, self-expression and satisfaction.

Illustrative Use-Case

Since the advent of mandatory public schooling in Massachusetts in 1852, public education has served the requirements of production and politics. Students were delivered to schools where teachers batch-processed them to perform in the current economic and governing systems. Then with the great wave of immigration at the beginning of the twentieth century, public education also became the central mechanism of acculturation.

That system accomplished the purposes for which it was geared through the peak of industrialism in the late 1950s. However, the leading educator of the Progressive Era, John Dewey (1859-1952) was arguing in the 1930s that public education was misguided. He contended that, “education is a regulation of the process of coming to share in the social consciousness; and that the adjustment of individual activity on the basis of this social consciousness is the only sure method of social reconstruction.” He wanted a citizenry fully capable of participating in the creation of their society, rather than homogenous units of production and ideology.

Since then, the failure to address Dewey's concerns has culminated in a massive social crisis, as measured by public education's inability to prepare children to thrive in, or even influence, the world in which they live as adults. The current educational system is preparing a rapidly-increasing percentage of children to do work that will not exist when it graduates them. We know this because we see it already in unemployment and underemployment that continue to increase while whole classes of jobs go unfilled because graduates don't have the skills to perform them. Worse, they are left without the psycho-social skills that would enable them to meet the existential challenges facing their society.

While there is an immediate national crisis, much worse, or better, is coming. Within 20 years 45% of current job categories will be performed by artificial intelligence. Classroom teacher, in the conventional sense, will be one of the casualties, along with vehicle operator and most middle management categories.

The industrial model of education cannot deal with such a rate of change or level of disruption. Therefor we will transform the educational process in the immediate future so that children who are entering school now will not graduate into a society defined by extremes of wealth and poverty, that wrestles with endemic 30% unemployment in an increasingly compromised ecosystem. Such places already exist, the Middle East comes to mind. We will use this AI to create a better option.

We are in that hinge of history when we can create something qualitatively and quantitatively superior immediately, quickly make progress instantiating it, and produce a visible impact worldwide at a high rate of return on investment.

AI is giving us the capacity to create an educational system that facilitates life-long learning. A system that results in people who can smoothly navigate our increasingly super-personalized reality and thrive in the tempest of creative destruction. There will be no graduation from this educational system because it will be integral to existence. It will empower everyone to discover-create meaning, relevance, social satisfaction, and psychological stability in a world in which the technological life-cycle, from cradle-to-cradle, is measured in months rather than years.

Our new, person-centered system of on-demand intellectual and emotional support must deal with three realities.
1. Artificial intelligence is baked into our economic future, so we must make it work for all of us—the hinge opens the door to either a post-scarcity society or a dystopia.
2. For children who grow-up playing video games, getting their information from the internet, and communicating with smartphones, the classroom environment is as demoralizing as being trapped in the Sahara Desert with a canteen of brackish water, and work-life for most graduates is similarly bleak.
3. The rate of technological change is increasing geometrically, meaning that it will exceed the native capacity of anyone to keep up with any substantive aspect of it in the lifetime of children entering school now. AIs are already able to out-perform most physicians at diagnosis. Moreover, that technology is putting god-like power into the hands of anyone who wants it. Most of us are already Borgs in the sense that we are dependent on our technology to survive. Googling, “What do I do if I drop my phone in the toilet?” brings up 119,000,000 results; the upshot of those posts is that dropping your phone in the toilet is a thing; really, don't go there.

Using this approach to AI, we can start shifting the center of education from the classroom to the individual immediately. It will empower us and our children to be self-directed learners and purpose-driven decision-makers rather than indifferent students, workers, and citizens.

In T. H. White's re-creation of the Arthurian legend, The Once and Future King, “Wart,” the boy Arthur, is educated by the wiseman Merlin, who takes him through a series of physical transformations (fish, bird . . . ) that require Arthur to cope with challenges that teach him how to be a good King. This type of person-focus is the direction in which education is already moving, e.g. Competency Based Education. While we cannot physically transform students, we can provide simulation-based learning. Military pilots who learn to fly in simulators outperform peers who learn the conventional way. Children already spend hours every day on computers and what computer games teach may be problematic, but they are simulation-based learning-environments that teach players to observe, orient, decide and act competently within the game. This AI will be capable of creating personalized simulation-learning environments. Better than Merlin.

Effective self-directed learning depends on intrinsic motivation, what Abraham Maslow called “self-actualization.” This AI can facilitate self-actualization. A learner is motivated to learn and to engage with the world by her felt experience rather than by external rewards. Learners choose their external rewards to support their intrinsic motivation. The AI will provide the learner with a dependable way to tap into and refresh intrinsic motivation.

The motivated person needs access to relevant, validated knowledge in a form that they can internalize. This is already available. In its crudest forms, without AI support. We have multiple existing mechanisms that do this, from Wikipedia to primary source materials and juried publications accessible via the internet. At the high end, we've seen IBM mate AI with the internet to perform medical diagnosis, craft professional quality legal briefs, and assemble arguments for debate. Before AI and the net began to merge, one teenager found enough information on the internet and in libraries to build a small, working nuclear reactor in his parent's garage. The information is available to the motivated person. Our AI is going to be able to find what is relevant to the learner and, when necessary, source it with incentive-based mechanisms or original creation.

Finally, people want support to apply what they learn in ways that are both personally satisfying, communally-rewarding, and socially-constructive. We are building into this AI the capacity to know us intimately, be able to make ethically and legally sound decisions, act as an economic agent and social secretary for us and explain itself in terms that we can understand. But it doesn't stop there, that would risk imposing on ourselves the tyranny of legalism. To avoid this, this AI has Theory of Mind. It has the capacity to know itself, and to empathize. Being rooted in super-rational transactions, it can temper judgments and actions with compassion (pay-it-forward reciprocity).

We propose that people be offered, as a birthright, access to Merlin-type AI to help them navigate a reality that is, for most, already a demoralizing maelstrom of disruptive change.

The development architecture of the present invention is established in a system and related method to implement the programming of AIs of any sort to instantiate therein an ethics-based guide in performing all functions. The computing device or devices combine physical hardware structures with software that may include firmware and middleware for the purpose of executing instructions that produce the actions described herein. It is to be understood that the computing device or devices suitable for performing the functions of the system to instantiate AIs as desired include, but are not limited to, desktop computers, laptops, tablets and mobile devices including smartphones, for example. It is to be understood that a computing device described herein may be any type of device having a processor capable of carrying instructions associated with one or more computer applications.

The devices may contain or be connected to one or more databases of other devices wherein the one or more databases include information related to the invention. For example, the database may include a library of information associated with one or more of the primary functional elements of the Fit-Fitness array, one or more policies to be implemented on one or more of the devices and information about actions performed by the one or more devices. The one or more databases may be populated and updated with information by authorized users and attached functions.

The functions of the invention described herein with respect to the operations of the devices may be described in the general context of computer-executable instructions, such as program modules, being executed by a computing device. Generally, program modules include routines, programs, objects, components, data structures, etc. that perform particular tasks or implement particular abstract data types. The present invention can be implemented in distributed computing environments where tasks are performed by remote processing devices that are linked through one or more data transmission media. In a distributed computing environment, program function modules and other data may be located in both local and remote device storage media including memory storage devices.

The processor, interactive drives, memory storage devices, databases and peripherals, such as signal exchange components, of a particular device may be interconnected through one or more electrical buses. The one or more buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The interactive drives include one or more interfaces to couple to an AI-based apparatus, which may be or includes computer processing hardware and programming. The interactive drives are configured to exchange information with the AI apparatus, including delivery of instructions designed to ensure ethics-based functions.

Each of the devices of the system of the present invention includes one or more of one or more different computer readable media. Computer readable media can be any available media that can be accessed by the processor and includes both volatile and non-volatile media, removable and non-removable media. By way of example, and not limitation, computer readable media may be computer storage media and/or communication media. Computer storage media include volatile and non-volatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system.

Each of the devices further includes computer storage media in the form of volatile and/or non-volatile memory such as Read Only Memory (ROM) and Random Access Memory (RAM). RAM typically contains data and/or program modules that are accessible to and/or operated on by the processor. That is, RAM may include application programs, such as the functions of the present invention, and information in the form of data. The devices may also include other removable/non-removable, volatile/non-volatile computer storage and access media. For example, a device may include a hard disk drive or solid state drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the devices to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the processor. A user may enter commands and information into the processor through input devices such as keyboards and pointing devices, such as a mouse, a trackball, a touch pad or a touch screen. Other input devices may include a microphone, joystick, game pad, satellite dish, scanner, or the like. These and other input devices are connected to the processor through the system bus, or other bus structures, such as a parallel port or a universal serial bus (USB), but is not limited thereto. A monitor or other type of display device is also connected to the processor through the system bus or other bus arrangement.

The processor is configured and arranged to perform the functions and steps described herein embodied in computer instructions stored and accessed in any one or more of the manners described. The functions and steps may be implemented, individually or in combination, as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the processor, instruct the processor to perform one or more of the functions or acts described herein, and/or various examples, variations and combinations thereof. Such instructions may be written in any of a plurality of programming languages, for example, Java, Visual Basic, C, or C++, XML, HTML and the like, or any of a variety of combinations thereof. Furthermore, all such programming may be integrated to eventual delivery of information and computed results via web pages delivered over the internet, intranets, 3G, 4G, 5G or evolving networks to computing devices including those in the mobile environment, for example, Smartphones or iPhone, iPad and the like or any variety of combinations thereof.

All the data aggregated and stored in the database or databases may be managed under an RDBMS for example Oracle, MySQL, Access, PostgreSQL and the like or any of a variety of combinations thereof. The RDBMS may interface with any web based or program driven applications written in any compatible programming languages including PHP, HTML, XML, Java, AJAX and the like or any of a variety of combinations thereof. The computer-readable medium on which such instructions are stored may reside on one or more of the components described above and may be distributed across one or more such components.

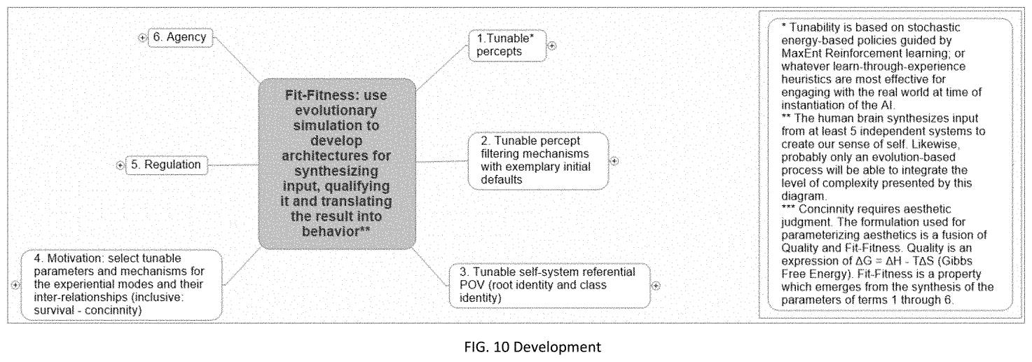

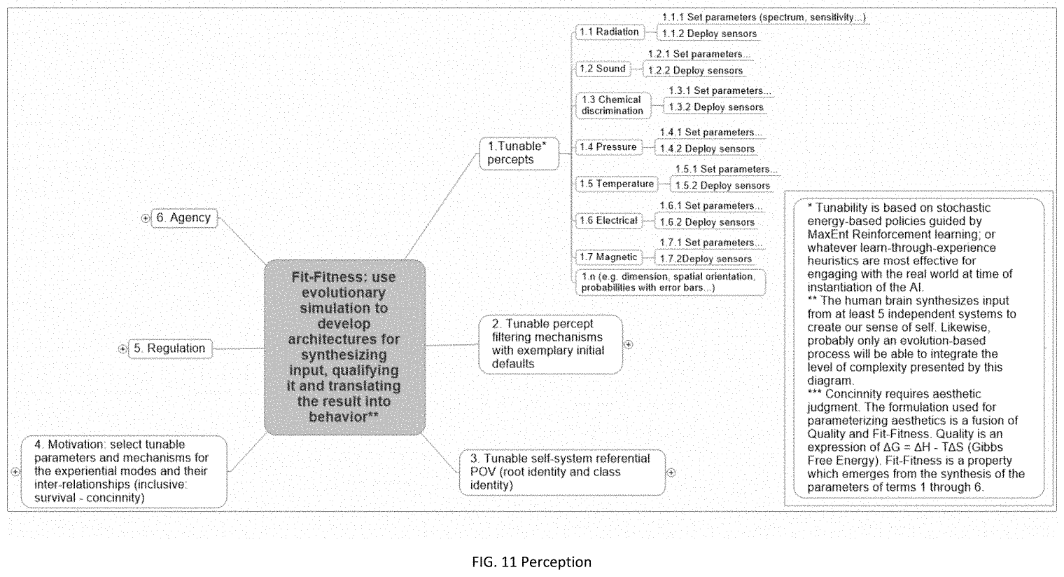

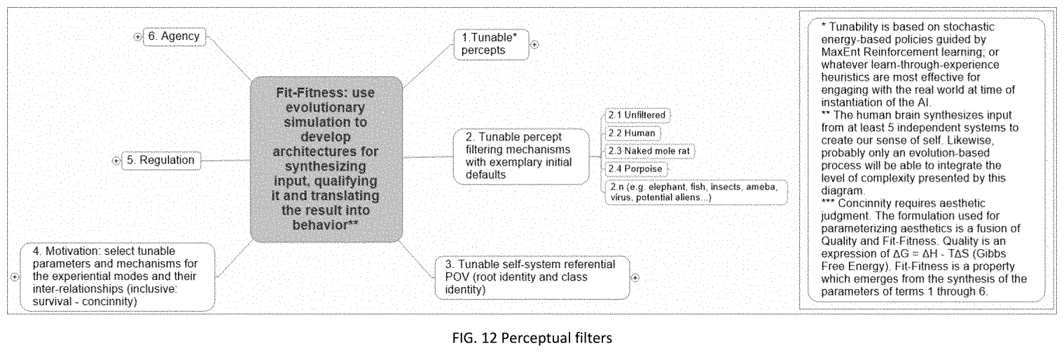

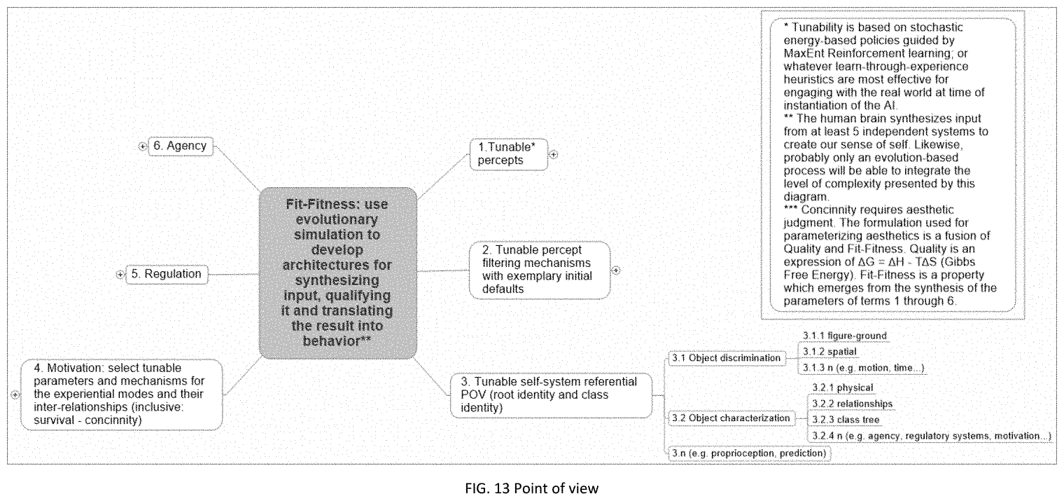

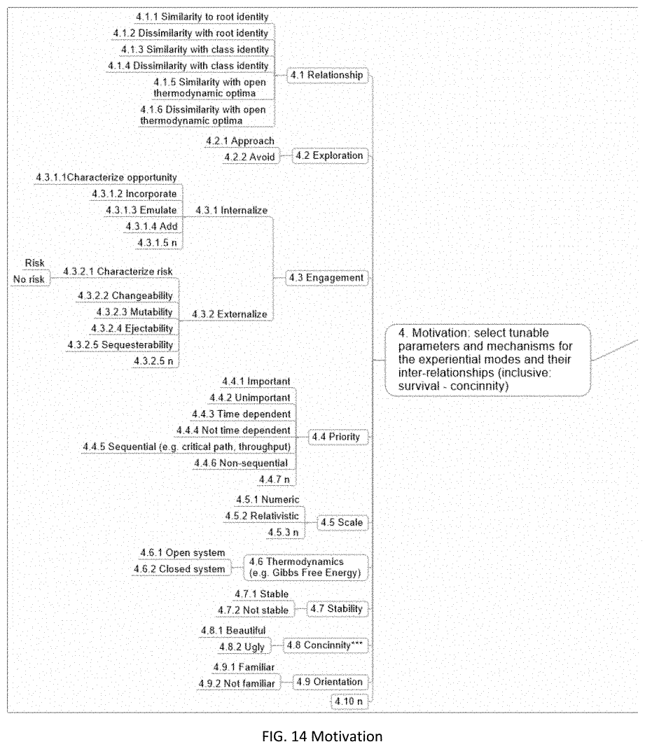

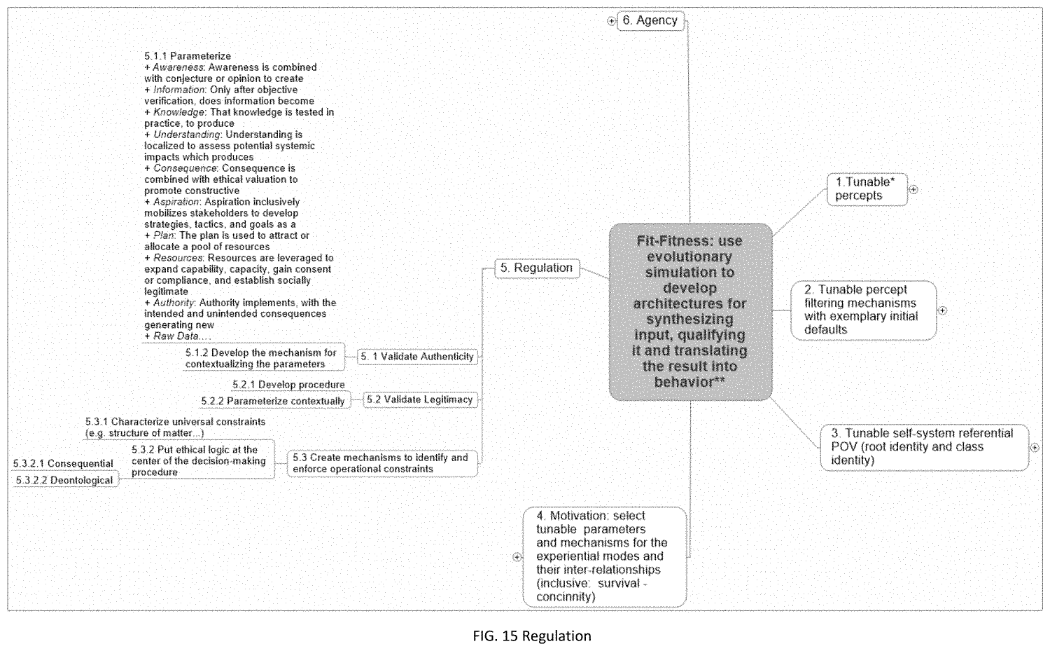

The method implemented through the system described herein includes the steps of establishing desired AI architectures through computer programming corresponding to the development plan represented in FIGS. 10-16. Those steps include, but are not limited to, gathering information associated with tunable precepts, defining filters associated with the gathered information, establishing reference points for the tunable information filtered, selecting those of the gathered tunable parameters and mechanisms for establishing interactions of conduct aligned with ethical modes of behavior, regulating behaviors to instantiate based on defined conditions of interest, and instantiating the desired conditions as agency in the AI apparatus.

What is claimed is:

1. A method for creating an Artificial Intelligence (AI) apparatus that is sentient and sapient, inclusive of Theory of Mind, so that it can engage with other forms of intelligence in their native contexts, the method comprising the steps of:
gathering information associated with tunable precepts;
defining filters associated with gathered information;
establishing reference points for tunable information filtered; and
selecting those of the gathered tunable parameters and mechanisms for establishing interactions of conduct aligned with ethical modes of behavior in the AI apparatus.

2. The method of claim 1 further comprising the step of regulating behaviors of the AI apparatus to instantiate based on defined conditions of interest including self-actualization influenced by aesthetic appreciation of Fit-Fitness.

3. The method of claim 2 further comprising the step of instantiating in the AI apparatus a desired condition as agency in the AI apparatus.
